(19) United States
(12) Patent Application Publication
(10) Pub. No.: US 2026/0015039 A1
(43) Pub. Date: Jan. 15, 2026

(54) DRIVER MONITOR, METHOD, AND COMPUTER PROGRAM FOR MONITORING DRIVER

(71) Applicant: TOYOTA JIDOSHA KABUSHIKI KAISHA, Toyota-shi Aichi-ken (JP)

(72) Inventors: Keisuke Suzuki, Yokohama-shi Kanagawa-ken (JP); Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 19/257,599

(22) Filed: Jul. 2, 2025

(30) Foreign Application Priority Data
Jul. 9, 2024 (JP) 2024-110226

(51) Int. Cl. B62D 15/02; G06V 10/82; G06V 20/59

(52) U.S. Cl. CPC B62D 15/029; G06V 20/597; G06V 10/82

(57) ABSTRACT

A driver monitor includes a processor configured to: determine whether a hands-on request condition for requesting a driver of a vehicle to hold a steering wheel is met, based on the situation of the vehicle or the state of the driver, notify the driver of a hands-on request for holding the steering wheel via a notification device provided in the vehicle when the driver has not held the steering wheel for a predetermined wait time while the hands-on request condition is met, detects the driver changing the manner of holding the steering wheel, and set the wait time, depending on a frequency of notification of the hands-on request given when changing the manner of holding the steering wheel is detected.

### CROSS-REFERENCE TO RELATED APPLICATIONS

This application claims priority to Japanese Patent Application No. 2024-110226 filed Jul. 9, 2024, the entire contents of which are herein incorporated by reference.

### FIELD

The present disclosure relates to a driver monitor, a method, and a computer program for monitoring a driver of a vehicle.

### BACKGROUND

A proposed technique requests a driver to hold a steering wheel under a predetermined condition when a vehicle is automatically driven with the driver's hands off the steering wheel (see Japanese Patent No. 7409239). In this technique, a driver monitoring system notifies a driver of a hands-on request or a surroundings check request again when the time elapsed since notification of a hands-on request or a surroundings check request exceeds a reference time. In addition, the driver monitoring system sets the reference time, depending on vehicle surroundings information.

### SUMMARY

When a driver changes the manner of holding a steering wheel while a condition for notification of a hands-on request is met, it may be determined that the driver's hands are off the steering wheel at the change, and notification of a hands-on request may be given. In such a case, the driver may be annoyed at the notification.

It is an object of the present disclosure to provide a driver monitor that can notify a driver of a hands-on request at an appropriate timing.

According to an embodiment, a driver monitor is provided. The driver monitor includes a processor configured to: determine whether a hands-on request condition for requesting a driver of a vehicle to hold a steering wheel is met, based on the situation of the vehicle or the state of the driver, notify the driver of a hands-on request for holding the steering wheel via a notification device provided in the vehicle when the driver has not held the steering wheel for a predetermined wait time while the hands-on request condition is met, detect the driver changing the manner of holding the steering wheel, and set the wait time, depending on a frequency of notification of the hands-on request given when changing the manner of holding the steering wheel is detected.

In an embodiment, the processor lengthens the wait time by a first amount of adjustment when the frequency of notification of the hands-on request is not less than a first threshold.

In an embodiment, the processor shortens the wait time by a second amount of adjustment when the frequency of notification of the hands-on request is not greater than a second threshold that is less than the first threshold.

According to another embodiment, a driver monitor is provided. The driver monitor includes a processor configured to: determine whether a hands-on request condition to request a driver of a vehicle to hold a steering wheel is met, based on the situation of the vehicle or the state of the driver, detect the driver changing the manner of holding the steering wheel, notify the driver of a hands-on request for holding the steering wheel via a notification device provided in the vehicle when changing the manner of holding the steering wheel is not detected, and omit notification of the hands-on request when changing the manner of holding the steering wheel is detected, in the case where the hands-on request condition is met and where the driver has not held the steering wheel for a predetermined wait time.

According to still another embodiment, a method for monitoring a driver is provided. The method includes determining whether a hands-on request condition for requesting a driver of a vehicle to hold a steering wheel is met, based on the situation of the vehicle or the state of the driver; notifying the driver of a hands-on request for holding the steering wheel via a notification device provided in the vehicle when the driver has not held the steering wheel for a predetermined wait time while the hands-on request condition is met; detecting the driver changing the manner of holding the steering wheel; and setting the wait time, depending on a frequency of notification of the hands-on request given when changing the manner of holding the steering wheel is detected.

The driver monitor according to the present disclosure has an effect of being able to notify a driver of a hands-on request at an appropriate timing.

### BRIEF DESCRIPTION OF DRAWINGS

FIG. 1 schematically illustrates the configuration of a vehicle control system including a driver monitor.

FIG. 2 illustrates the hardware configuration of an ECU, which is an example of the driver monitor.

FIG. 3 is a functional block diagram of a processor of the ECU.

FIG. 4 illustrates an example of the relationship between a notification frequency of hands-on requests and a wait time.

FIG. 5 is an operation flowchart of a driver monitoring process.

### DESCRIPTION OF EMBODIMENTS

A driver monitor, a method for monitoring a driver executed by the driver monitor, and a computer program for monitoring a driver will now be described with reference to the attached drawings. The driver monitor notifies a driver of a hands-on request to request the driver to hold a steering wheel, when the driver has not held the steering wheel for a predetermined wait time since a hands-on request condition for a hands-on request is met. The driver monitor adjusts the wait time, depending on the frequency of hands-on requests made when changing the manner of holding the steering wheel by the driver is detected. In this way, the driver monitor reduces notification of hands-on requests caused by the driver changing the manner of holding the steering wheel.

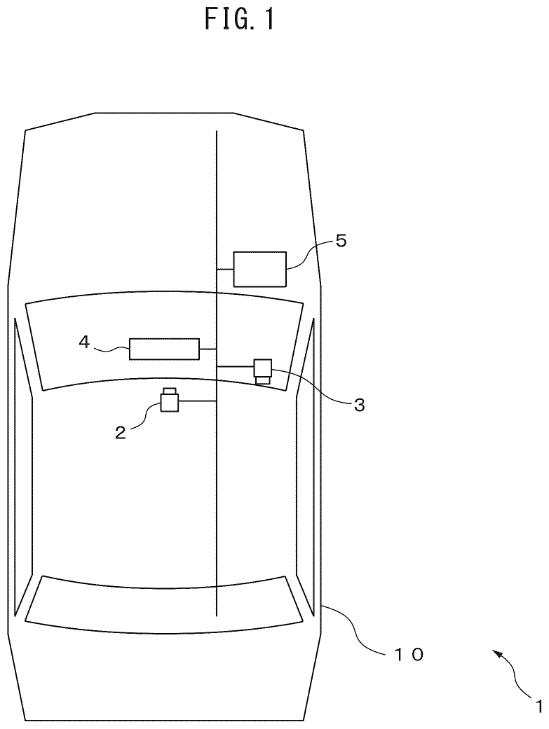

FIG. 1 schematically illustrates the configuration of a vehicle control system including a driver monitor. In the present embodiment, the vehicle control system 1, which is mounted on a vehicle 10 and controls the vehicle 10, includes a vehicle exterior camera 2, a driver monitoring camera 3, a notification device 4, and an electronic control unit (ECU) 5, which is an example of the driver monitor. The vehicle exterior camera 2, the driver monitoring camera 3, and the notification device 4 are communicably connected to the ECU 5. The vehicle 10 may also include a range sensor (not illustrated) that measures the distances to objects around the vehicle 10, such as LiDAR or radar. The vehicle 10 may further include a position determining device (not illustrated) for determining the position of the vehicle 10 by a satellite positioning system, such as a GPS receiver.

The vehicle exterior camera 2, which is an example of an exterior image capturing unit, is mounted on the vehicle 10 so as to face a predetermined region in the vicinity of the vehicle 10, such as a region in front of the vehicle 10. The vehicle 10 may include multiple vehicle exterior cameras taking pictures in different orientations or having different focal lengths. Every predetermined capturing period, the vehicle exterior camera 2 takes a picture of the predetermined region to generate an image representing the predetermined region (hereafter a “vehicle exterior image”) and outputs the generated vehicle exterior image to the ECU 5.

The driver monitoring camera 3, which is an example of an interior image capturing unit, is mounted on or near an instrument panel and oriented to the driver so that the head of the driver sitting on the driver's seat of the vehicle 10 is included in the region to be captured by the camera. The driver monitoring camera 3 may include a light source, such as an infrared LED. Every predetermined capturing period, the driver monitoring camera 3 takes a picture of the driver to generate an image representing the driver (hereafter a “driver image”) and outputs the generated driver image to the ECU 5.

The notification device 4 is provided in the interior of the vehicle 10, and gives predetermined notification to the driver by light, voice, vibration, or display of text or an image. To achieve this, the notification device 4 includes, for example, at least one of a speaker, a light source, a vibrator, or a display. When a notification signal indicating predetermined notification to the driver is received from the ECU 5, the notification device 4 gives the notification to the driver by a voice from the speaker, lighting up or blinking the light source, vibration of the vibrator, or displaying a notification message or an icon on the display.

The ECU 5 executes autonomous driving control of the vehicle 10 or assists the driver of the vehicle 10 in driving, according to an applied driving mode. In addition, the ECU 5 monitors the driver of the vehicle 10 to give notification of a hands-on request via the notification device 4 as necessary.

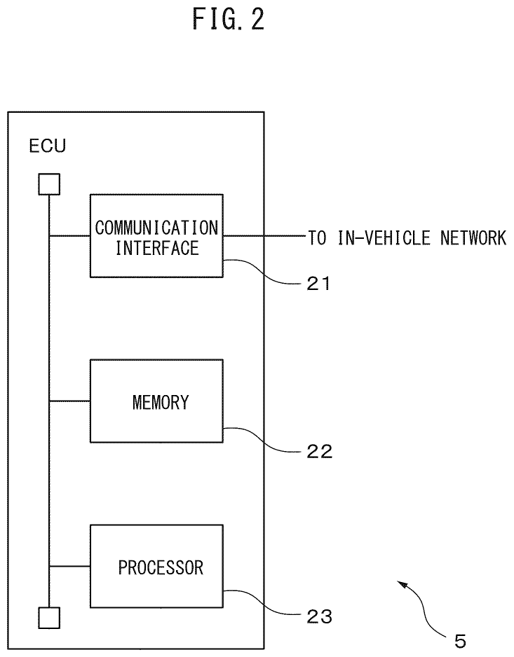

FIG. 2 illustrates the hardware configuration of the ECU 5. As illustrated in FIG. 2, the ECU 5 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 5 to another device inside the vehicle. The communication interface 21 passes a vehicle exterior image received from the vehicle exterior camera 2 and a driver image received from the driver monitoring camera 3 to the processor 23. Further, the communication interface 21 outputs a notification signal received from the processor 23 to the notification device 4.

The memory 22, which is an example of a storage unit, includes, for example, volatile and nonvolatile semiconductor memories. The memory 22 stores various types of data used in a driver monitoring process executed by the processor 23.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes a driver monitoring process.

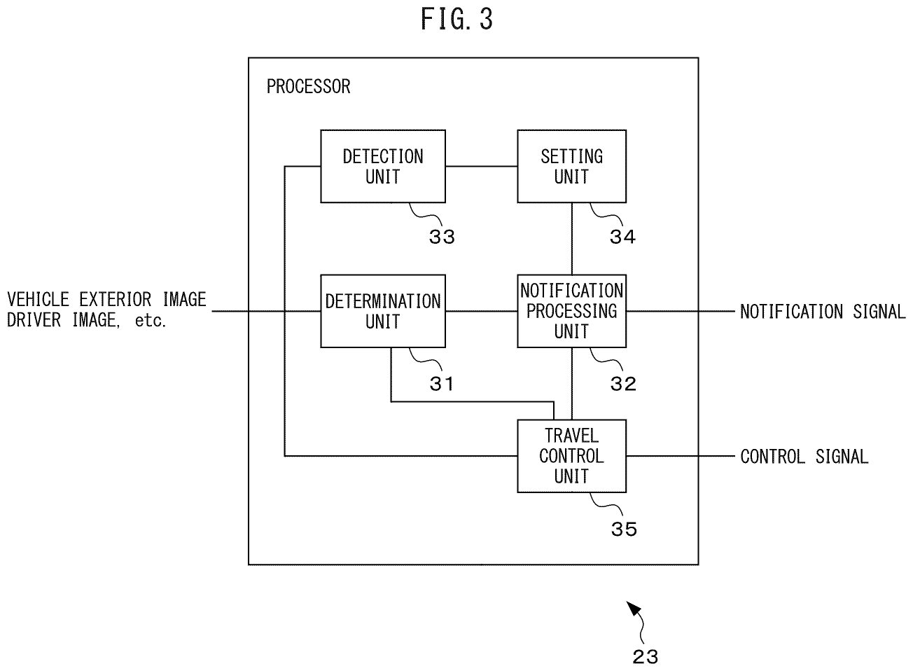

FIG. 3 is a functional block diagram of the processor 23, related to the driver monitoring process. The processor 23 includes a determination unit 31, a notification processing unit 32, a detection unit 33, a setting unit 34, and a travel control unit 35. These units included in the processor 23 are, for example, functional modules implemented by a computer program executed by the processor 23, or may be dedicated operating circuits provided in the processor 23.

The determination unit 31 determines whether a hands-on request condition is met, based on the situation of the vehicle 10 or the state of the driver of the vehicle 10. The hands-on request condition is a condition for requesting the driver to hold the steering wheel.

In an embodiment, the determination unit 31 determines that the hands-on request condition is met, when the vehicle 10 is in a situation where it is difficult to continue autonomous driving control of the vehicle 10. For example, the determination unit 31 determines that the hands-on request condition is met, when the travel control unit 35 cannot detect a lane line from vehicle exterior images or when notified by the travel control unit 35 that the distance between the vehicle 10 and a lane line demarcating a host vehicle lane being traveled by the vehicle 10 has fallen below a predetermined lower-limit threshold.

Further, the determination unit 31 determines that the hands-on request condition is met, when the driver is in such a state that the driver is not ready for taking over driving the vehicle 10 from the ECU 5. For example, the determination unit 31 determines that the hands-on request condition is met, when the driver is in a state where the driver gives a sign of sleepiness, keeps looking away, or has not held the steering wheel for more than a hands-off upper-limit period.

To determine whether the hands-on request condition is met, the determination unit 31 estimates the driver's state, based on driver images. For example, the determination unit 31 estimates the driver's sleepiness level at predetermined intervals, based on a series of driver images obtained in a most recent certain period. When the driver's sleepiness level is not lower than a predetermined level, the determination unit 31 determines that there is a sign of the driver's sleepiness. To achieve this, the determination unit 31 detects the driver's looking direction and the degrees of opening of the eyes and the mouth (hereafter referred to as the “eye opening level” and the “mouth opening level,” respectively) of the driver from each of the series of driver images. The determination unit 31 estimates the driver's sleepiness level, based on the detected looking direction, eye opening level, and mouth opening level.

The determination unit 31 detects a region representing the driver's face (hereafter a “face region”) in a driver image by inputting the driver image into a classifier that has been trained to detect a driver's face from a driver image. Such a classifier is configured, for example, a deep neural network (DNN) having architecture of a convolutional neural network (CNN) type, e.g., Single Shot MultiBox Detector (SSD) or Faster R-CNN, or a DNN having architecture of an attention mechanism, e.g., Vision transformer. Alternatively, such a classifier may be configured as a classifier based on another machine learning technique other than a DNN, such as an AdaBoost classifier. The classifier is pre-trained in accordance with a predetermined training technique, such as backpropagation, with a large number of training images representing a human face. In addition, the determination unit 31 detects the driver's eyes and mouth from the face region. To this end, the determination unit 31 applies, for example, an edge detection filter, such as a Sobel filter, to detect edge pixels in the face region. The determination unit 31 then detects lines of edge pixels extending in a substantially horizontal direction, and detects, for each of the left and right eyes, such two lines separated vertically in an area in the face region where the eye is supposed to lie, as the upper and lower eyelids of the eye. Similarly, the determination unit 31 detects a sub-region defined by such two lines separated vertically in an area in the face region where the mouth is supposed to lie, as the driver's mouth. The determination unit 31 may detect the upper and lower eyelids of the driver's left and right eyes from a driver image in accordance with another technique to detect upper and lower eyelids from an image. Similarly, the determination unit 31 may detect the driver's mouth from a driver image in accordance with another technique to detect a mouth from an image. For example, the classifier for detecting a face region may be pre-trained to detect the upper and lower eyelids and the mouth directly from a driver image. In this case, the determination unit 31 can detect the upper and lower eyelids and the mouth by inputting a driver image into the classifier.

For each of the latest series of driver images, the determination unit 31 estimates the driver's eye opening level, based on the distances between the upper and lower eyelids of the left and right eyes. For example, the determination unit 31 determines the average of the distances between the upper and lower eyelids of the left and right eyes as the eye opening level. The determination unit 31 may estimate the eye opening level in accordance with another technique to calculate an eye opening level from upper and lower eyelids in an image. The determination unit 31 calculates the interval between maxima of the eye opening level from time-varying changes in the eye opening level in the series of driver images as the duration of the driver's single blink. The determination unit 31 then counts the number of blinks in the most recent certain period, and calculates the average of intervals between blinks as the period of a blink. In addition, the determination unit 31 calculates the ratio of the vertical length of the mouth to the horizontal length thereof for each driver image in the most recent certain period, and calculates the average of the ratios as the driver's mouth opening level. The determination unit 31 may calculate the driver's mouth opening level in accordance with another technique to calculate a mouth opening level from a region representing a mouth in an image.

In addition, the determination unit 31 detects the driver's looking direction from each of the latest series of driver images. For example, in at least one of the driver's left and right eyes represented in each driver image, the determination unit 31 detects a corneal reflection image of a light source and the centroid of the pupil (hereafter simply the “pupillary centroid”) from the region defined by the upper and lower eyelids (hereafter the “eye region”). A corneal reflection image of a light source is also referred to as a Purkinje image. Specifically, the determination unit 31 detects a Purkinje image, for example, by template matching of the eye region with templates of a Purkinje image. Similarly, the determination unit 31 detects the pupil by template matching of the eye region with templates of a pupil, and determines the centroid of the region representing the detected pupil as the pupillary centroid. The determination unit 31 may detect a Purkinje image and the pupillary centroid in accordance with another technique to detect them from an eye region. The determination unit 31 then calculates the distance and direction from the Purkinje image to the pupillary centroid, and refers to a table representing the relationship between the distance and direction and a driver's looking direction, thereby detecting the driver's looking direction. Such a table may be prestored in the memory 22. The determination unit 31 determines the amount of change in the looking direction for each pair of successive driver images, and divides the average of the amounts of change by the interval of acquisition of the driver images, thereby calculating the rate of change in the looking direction.

The determination unit 31 estimates the driver's sleepiness level, based on at least one of the number and frequency of blinks, the mouth opening level, and the rate of change in the looking direction, and determines that there is a sign of the driver's sleepiness, when the sleepiness level is not lower than a predetermined level. For example, the determination unit 31 determines that there is a sign of the driver's sleepiness, in the case where the number of blinks in the most recent certain period is not less than a predetermined number, the period of a blink is longer than a predetermined time threshold, the rate of change in the looking direction is not higher than a predetermined speed threshold, and the mouth opening level is higher than a predetermined opening level. When at least one of the number and frequency of blinks, the mouth opening level, and the rate of change in the looking direction in the most recent certain period does not meet the above-mentioned condition, the determination unit 31 determines that there is not a sign of the driver's sleepiness. Alternatively, the determination unit 31 may set a condition for detecting a sign of sleepiness regarding a combination of three or fewer of the number and frequency of blinks, the mouth opening level, and the rate of change in the looking direction. The determination unit 31 determines that there is a sign of the driver's sleepiness, when the detection condition is met; and determines that there is not a sign of the driver's sleepiness, when the detection condition is not met. When there is a sign of the driver's sleepiness, the determination unit 31 determines that the hands-on request condition is met.

Further, when the looking direction is outside a predetermined angle range corresponding to the forward direction of the vehicle 10, the determination unit 31 determines that the driver is not looking in the travel direction of the vehicle. Thus, when the driver's looking direction has been outside the predetermined angle range for a predetermined period, the determination unit 31 determines that the driver is in a state of keeping looking away, and thus the hands-on request condition is met.

In addition, when the value of a signal outputted from a touch sensor (not illustrated) provided in the steering wheel indicates that the driver has not held the steering wheel for more than a hands-off upper-limit period, the determination unit 31 determines that the driver is in a state where the driver has not held the steering wheel, and that the hands-on request condition is met. Alternatively, the determination unit 31 may detect a hand region and a steering wheel region representing the driver's hand and the steering wheel, respectively, in a driver image by inputting the driver image into a classifier that has been trained to detect a driver's hand and a steering wheel. The determination unit 31 may then determine that the driver is not holding the steering wheel, when the hand region and the steering wheel region are separated in the driver image by more than a predetermined interval. In this case also, the determination unit 31 determines that the hands-on request condition is met, when determination that the driver is not holding the steering wheel has been made based on driver images for more than the hands-off upper-limit period. The classifier for detecting a hand region and a steering wheel region is configured as a DNN having a CNN or an attention mechanism.

At each change of the result of determination whether the hands-on request condition is met, the determination unit 31 outputs the result of determination to the notification processing unit 32 and the setting unit 34.

The notification processing unit 32 notifies the driver of a hands-on request via the notification device 4 when the driver has not held the steering wheel for a wait time since reception of the result of determination that the hands-on request condition is met from the determination unit 31. The notification processing unit 32 determines whether the driver is holding the steering wheel, based on a signal from the touch sensor provided in the steering wheel or a driver image, as described above in relation to the determination unit 31.

When the hands-on request condition is no longer met or the driver holds the steering wheel before the elapse of the wait time after the hands-on request condition is met, the notification processing unit 32 omits notification of a hands-on request. In addition, when the driver holds the steering wheel after the start of notification of a hands-on request, the notification processing unit 32 stops notification of the hands-on request.

When the driver does not hold the steering wheel even after a first waiting period from the start of notification of a hands-on request, the notification processing unit 32 may intensify notification of the hands-on request. For example, the notification processing unit 32 intensifies notification of a hands-on request by increasing the volume of sound from the speaker included in the notification device 4 or intensifying emission of the light source included in the notification device 4. Alternatively, the notification processing unit 32 may intensify notification by increasing the number of devices that give notification of a hands-on request.

When starting notification of a hands-on request, the notification processing unit 32 notifies the start to the setting unit 34. Similarly, when stopping notification of a hands-on request, the notification processing unit 32 notifies the stop to the setting unit 34. In addition, when a second waiting period has elapsed since the start of notification of a hands-on request without the driver holding the steering wheel, the notification processing unit 32 may notify this fact to the travel control unit 35. The second waiting period is set longer than the first waiting period.

The detection unit 33 detects that the driver has changed the manner of holding the steering wheel. For example, the detection unit 33 inputs multiple driver images sequentially in the order of generation of these driver images by the driver monitoring camera 3 into a classifier that has been trained to detect a change of the manner of holding the steering wheel. In this way, when the driver has changed the manner of holding the steering wheel, the classifier outputs a signal indicating that the change is detected. Such a classifier is configured as a DNN having a recursive structure, such as a recurrent neural network (RNN) or LSTM.

When a steering angle indicated by a signal received by the ECU 5 from a steering angle sensor (not illustrated) provided for the steering wheel exceeds a predetermined angular threshold, the detection unit 33 may detect changing the manner of holding the steering wheel by the driver. The predetermined angular threshold is set to a steering angle at which it is difficult to hold a steering wheel without changing the manner of holding the steering wheel.

Every time changing the manner of holding the steering wheel by the driver is detected, the detection unit 33 notifies the detection to the setting unit 34.

The setting unit 34 sets the length of the wait time, which is the period from when the hands-on request condition is met until actual notification of a hands-on request, depending on a frequency of notification of the hands-on request (hereafter a “notification frequency”) given when changing the manner of holding the steering wheel by the driver is detected.

In an embodiment, the setting unit 34 calculates the notification frequency as the ratio of the number of times of notification of a hands-on request at a change of the manner of holding the steering wheel to the time or distance of travel of the vehicle 10 during which the hands-on request condition is met. Thus, when notified by the determination unit 31 that the hands-on request condition is met, the setting unit 34 starts measuring the time of travel during which the hands-on request condition is met, and stores the current distance of travel of the vehicle 10 in the memory 22. When notified by the determination unit 31 that the hands-on request condition is no longer met, the setting unit 34 finishes measuring the time of travel during which the hands-on request condition is met. Further, the setting unit 34 subtracts the distance of travel of the vehicle 10 at the time of notification that the hands-on request condition is met, which is stored in the memory 22, from the distance of travel at the time of notification that the hands-on request condition is no longer met, thereby calculating the distance of travel during which the hands-on request condition is met. Every time the hands-on request condition is met, the setting unit 34 adds the time of travel determined as described above to the current sum of the time of travel during which the hands-on request condition is met. Similarly, every time the hands-on request condition is met, the setting unit 34 adds the distance of travel determined as described above to the current sum of the distance of travel during which the hands-on request condition is met.

A hands-on request made when changing the manner of holding the steering wheel is detected by the detection unit 33 is probably caused by changing the manner of holding the steering wheel. Thus the setting unit 34 counts the number of times of notification of a hands-on request given when changing the manner of holding the steering wheel by the driver is detected. The setting unit 34 divides the number of times by the sum of the time or distance of travel during which the hands-on request condition is met to calculate the notification frequency.

The setting unit 34 compares the notification frequency with a first threshold. When the notification frequency is not less than the first threshold, the setting unit 34 lengthens the wait time by a first amount of adjustment. In this way, the setting unit 34 can reduce notification of hands-on requests caused by the driver changing the manner of holding the steering wheel. Every time the notification frequency is not less than the first threshold, the setting unit 34 lengthens the wait time by a first amount of adjustment. However, in some embodiments, when the wait time reaches an upper-limit length, the setting unit 34 does not lengthen the wait time any longer. This prevents the period from when the hands-on request condition is met until actual notification of a hands-on request from being too long, and thus prevents notification of a hands-on request from being too rare.

In addition, the setting unit 34 compares the notification frequency with a second threshold. The second threshold is set to a value less than the first threshold. When the notification frequency is not greater than the second threshold, the setting unit 34 shortens the wait time by a second amount of adjustment. In this way, the setting unit 34 can reduce notification of hands-on requests during changing the manner of holding the steering wheel by the driver, and prevent notification of a hands-on request from being too rare. Every time the notification frequency is not greater than the second threshold, the setting unit 34 shortens the wait time by a second amount of adjustment. However, in some embodiments, the setting unit 34 does not shorten the wait time to less than a lower-limit length. The second amount of adjustment may be equal to or less than the first amount of adjustment.

At each change of the length of the wait time, the setting unit 34 may reset the notification frequency. After the notification frequency is reset and then the time or distance of travel exceeds a certain length, the setting unit 34 may compare a notification frequency re-calculated after the reset with the first and second thresholds.

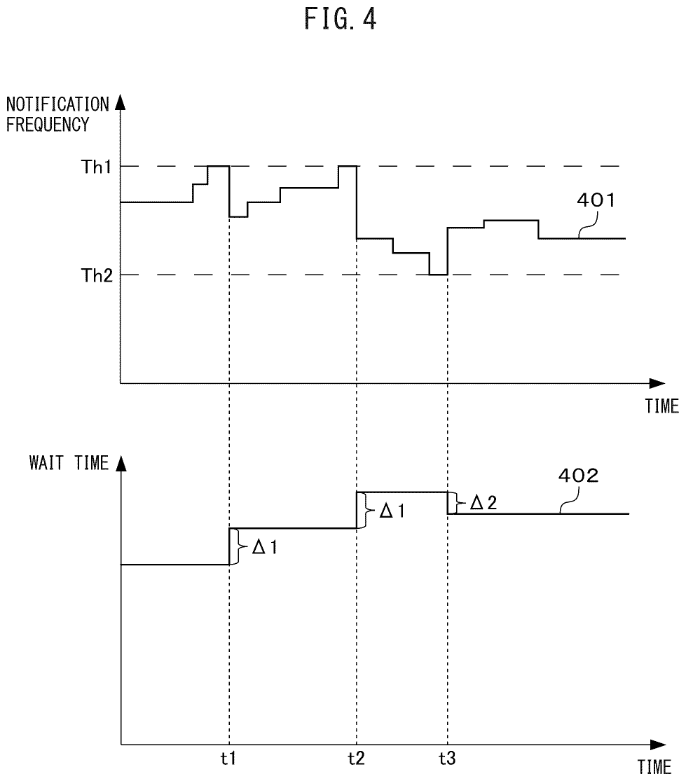

FIG. 4 illustrates an example of the relationship between a notification frequency of hands-on requests and a wait time. The abscissas of the upper and lower charts in FIG. 4 represent elapsed time. The ordinate of the upper chart represents a notification frequency, and a graph 401 represents time-varying changes in the notification frequency. The ordinate of the lower chart represents a wait time, and a graph 402 represents time-varying changes in the wait time.

As illustrated in the graphs 401 and 402, the wait time is kept constant until the notification frequency reaches a first threshold Th1. When the notification frequency reaches the first threshold Th1 at time t1, the wait time is adjusted to lengthen by a first amount of adjustment Δ1. Thereafter, the notification frequency temporarily falls below the first threshold Th1, but reaches the first threshold Th1 again at time t2. Hence, the wait time is adjusted again at time t2 to lengthen by a first amount of adjustment Δ1. In this way, the wait time lengthens every time the notification frequency reaches the first threshold, which reduces the frequency with which the time required to change the manner of holding the steering wheel exceeds the wait time, and thus reduces notification of hands-on requests at changing the manner of holding the steering wheel. Thereafter, the notification frequency falls to a second threshold Th2 at time t3. Hence, the wait time is adjusted to shorten by a second amount of adjustment Δ2 after time t3. In this way, the wait time shortens when the notification frequency is not greater than the second threshold, which prevents the wait time from being too long.

The travel control unit 35 controls travel of the vehicle 10 according to driving assistance mode corresponding to level 2 defined by the Society of Automotive Engineers (SAE) or level 3 autonomous driving mode. To achieve this, the travel control unit 35 detects a vehicle ahead and a lane line from vehicle exterior images. The travel control unit 35 detects another vehicle and a lane line by inputting a vehicle exterior image into a classifier that has been trained to detect lane lines and other traveling vehicle around the vehicle 10 from a vehicle exterior image. Such a classifier is configured as a DNN having a CNN or an attention mechanism. The travel control unit 35 identifies another vehicle in a region sandwiched between two lane lines closest to the vehicle 10 in the vehicle exterior image as a vehicle ahead. The bottom position of an object region representing a vehicle ahead in a vehicle exterior image is supposed to correspond to the position where the vehicle ahead is on the road surface. Thus the travel control unit 35 estimates the distance from the vehicle 10 to the vehicle ahead, based on parameters of the vehicle exterior camera 2, such as the orientation and the mounted position of the vehicle exterior camera 2, and the bottom position of the object region in the vehicle exterior image. When the vehicle 10 is equipped with a range sensor (not illustrated), the travel control unit 35 may estimate the distance measured by the range sensor in the direction corresponding to the object region representing the vehicle ahead to be the distance from the vehicle 10 to the vehicle ahead.

When the distance between the vehicle ahead and the vehicle 10 is less than a predetermined distance, the travel control unit 35 controls the power train or the brake of the vehicle 10 to increase the distance between the vehicle ahead and the vehicle 10. When the distance between the vehicle ahead and the vehicle 10 is not less than the predetermined distance, the travel control unit 35 controls the power train of the vehicle 10 so that the speed of the vehicle 10 approaches a target speed.

In addition, the travel control unit 35 sets a planned trajectory along the center of the two lane lines closest to the vehicle 10, and controls the steering device of the vehicle 10 so that the vehicle 10 travels along the set planned trajectory. When no lane line is detected from vehicle exterior images for a certain period, the travel control unit 35 notifies the determination unit 31 that detection of a lane line has failed. Further, the travel control unit 35 calculates the distances between the vehicle 10 and the two lane lines demarcating the host vehicle lane, based on the bottom positions of the two lane lines in vehicle exterior images, the parameters of the vehicle exterior camera 2, and the lengths from the mounted position of the vehicle exterior camera 2 to the left and right edges of the vehicle 10. When the distance between one of the lane lines and the vehicle 10 falls below a predetermined lower-limit threshold, the travel control unit 35 notifies this fact to the determination unit 31.

In addition, when notified by the notification processing unit 32 that the second waiting period has elapsed since the start of notification of a hands-on request without the driver holding the steering wheel, the travel control unit 35 may control the power train and the brake so that the vehicle 10 makes an emergency stop.

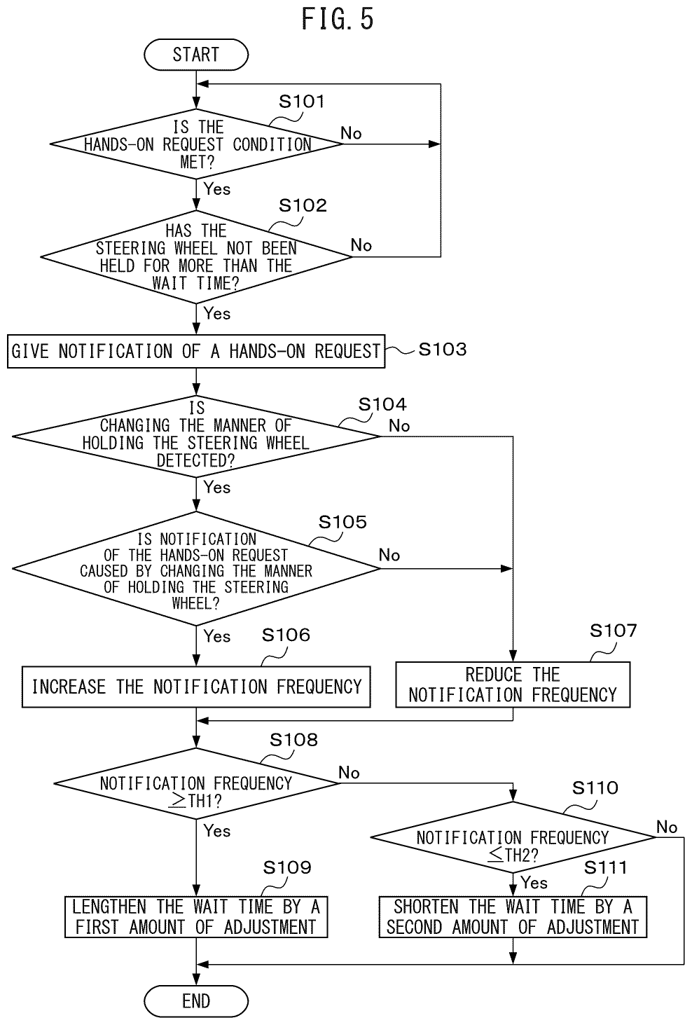

FIG. 5 is an operation flowchart of the driver monitoring process executed by the processor 23. The determination unit 31 determines whether the hands-on request condition is met (step S101). When the hands-on request condition is met (Yes in step S101), the notification processing unit 32 determines whether the wait time has elapsed without the driver holding the steering wheel (step S102). When the wait time has elapsed without the driver holding the steering wheel (Yes in step S102), the notification processing unit 32 notifies the driver of a hands-on request via the notification device 4 (step S103). When the driver holds the steering wheel before the elapse of the wait time (No in step S102) or when the hands-on request condition is not met (No in step S101), the processor 23 repeats the processing of step S101 and the subsequent steps without notification of a hands-on request by the notification processing unit 32.

The detection unit 33 detects changing the manner of holding the steering wheel by the driver (step S104). When changing the manner of holding the steering wheel is detected (Yes in step S104), the setting unit 34 determines whether notification of the hands-on request is given at detection of changing the manner of holding the steering wheel. In other words, the setting unit 34 determines whether notification of the hands-on request is caused by changing the manner of holding the steering wheel (step S105). When notification of the hands-on request is caused by the driver changing the manner of holding the steering wheel (Yes in step S105), the setting unit 34 corrects the notification frequency to increase the notification frequency (step S106). When changing the manner of holding the steering wheel is not detected (No in step S104) or when notification of the hands-on request is not caused by changing the manner of holding the steering wheel (No in step S105), the setting unit 34 corrects the notification frequency to reduce the notification frequency (step S107).

The setting unit 34 determines whether the notification frequency is not less than the first threshold Th1 (step S108). When the notification frequency is not less than the first threshold Th1 (Yes in step S108), the setting unit 34 lengthens the wait time by a first amount of adjustment (step S109). When the notification frequency is less than the first threshold Th1 (No in step S108), the setting unit 34 determines whether the notification frequency is not greater than the second threshold Th2 (step S110). When the notification frequency is not greater than the second threshold Th2 (Yes in step S110), the setting unit 34 shortens the wait time by a second amount of adjustment (step S111). After step S109 or S111 or when the notification frequency is greater than the second threshold Th2 in step S110 (No in step S110), the processor 23 terminates the driver monitoring process. The processing of steps S101 to S103 and that of step S104 may be executed in reverse order or in parallel.

As has been described above, the driver monitor adjusts the wait time, which is the period from when the hands-on request condition is met until actual notification of a hands-on request, depending on a frequency of notification of the hands-on request given when changing the manner of holding the steering wheel by the driver is detected. In this way, the driver monitor can reduce notification of hands-on requests caused by the driver changing the manner of holding the steering wheel, and thus notify the driver of a hands-on request at an appropriate timing.

According to a modified example, the notification processing unit 32 may omit notification of a hands-on request when the detection unit 33 is detecting changing the manner of holding the steering wheel by the driver, even if the hands-on request condition is met and the predetermined wait time has elapsed since the hands-on request condition is met. In other words, the notification processing unit 32 may notify the driver of a hands-on request via the notification device 4, only in the case where the hands-on request condition is met, where the predetermined wait time has elapsed since the hands-on request condition is met, and where changing the manner of holding the steering wheel by the driver is not detected. In this case, the processing of the setting unit 34 may be omitted. This modified example prevents notification of a hands-on request caused by the driver changing the manner of holding the steering wheel when the hands-on request condition is met.

The computer program for achieving the driver monitoring process of the above-described embodiment or modified example may be provided in a form recorded on a computer-readable portable storage medium.

As described above, those skilled in the art may make various modifications according to embodiments within the scope of the present disclosure.

What is claimed is:

1. A driver monitor comprising:
a processor configured to:
determine whether a hands-on request condition for requesting a driver of a vehicle to hold a steering wheel is met, based on a situation of the vehicle or a state of the driver,
notify the driver of a hands-on request for holding the steering wheel via a notification device provided in the vehicle when the driver has not held the steering wheel for a predetermined wait time while the hands-on request condition is met,
detect the driver changing a manner of holding the steering wheel, and
set the wait time, depending on a frequency of notification of the hands-on request given when changing the manner of holding the steering wheel is detected.

2. The driver monitor according to claim 1, wherein the processor lengthens the wait time by a first amount of adjustment when a frequency is not less than a first threshold.

3. The driver monitor according to claim 2, wherein the processor shortens the wait time by a second amount of adjustment when the frequency is not greater than a second threshold that is less than the first threshold.

4. A driver monitor comprising:
a processor configured to:
determine whether a hands-on request condition to request a driver of a vehicle to hold a steering wheel is met, based on a situation of the vehicle or a state of the driver,
detect the driver changing a manner of holding the steering wheel,
notify the driver of a hands-on request for holding the steering wheel via a notification device provided in the vehicle when changing the manner of holding the steering wheel is not detected, and
omit notification of the hands-on request when changing the manner of holding the steering wheel is detected, in a case where the hands-on request condition is met and where the driver has not held the steering wheel for a predetermined wait time.

5. A method for monitoring a driver, comprising:
determining whether a hands-on request condition for requesting a driver of a vehicle to hold a steering wheel is met, based on a situation of the vehicle or a state of the driver;
notifying the driver of a hands-on request for holding the steering wheel via a notification device provided in the vehicle when the driver has not held the steering wheel for a predetermined wait time while the hands-on request condition is met;
detecting the driver changing a manner of holding the steering wheel; and
setting the wait time, depending on a frequency of notification of the hands-on request given when changing the manner of holding the steering wheel is detected.
